(19) United States
(12) Patent Application Publication
(10) Pub. No.: US 2009/0300701 A1
(43) Pub. Date: Dec. 3, 2009

(54) AREA OF INTEREST PROCESSING OF VIDEO DELIVERED TO HANDHELD DEVICE

(75) Inventors: Jeyhan Karaoguz, Irvine, CA (US); Sherman (Xuemin) Chen, San Diego, CA (US); Michael Dove, Los Gatos, CA (US); David Rosmann, Irvine, CA (US); Thomas J. Quigley, Franklin, NC (US); Stephen E. Gordon, Lexington, MA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/189,401

(22) Filed: Aug. 11, 2008

Related U.S. Application Data
(60) Provisional application No. 61/056,623, filed on May 28, 2008.

(51) Int. Cl. H04N 7/173

(52) U.S. Cl. 725/119; 725/131

(57) ABSTRACT

Processing a video stream intended for a remote wireless device by a video processing system based upon identified area of interest information to produce an output video stream having lesser required data throughput. Operation commences with receiving the video stream and buffering the video stream. Then the video processing system identifies an area of interest corresponding to at least one video frame of the video stream. The video processing system the processes the video frames of the video stream based upon the identified area of interest to produce an output video stream. The video processing system then transmits the output video stream for delivery to the remote wireless device. Processing video frames of the video stream may include altering pixel resolution, color resolution, and/or cropping video information of the video frames outside of the area of interest.

### CROSS-REFERENCE TO RELATED APPLICATIONS

The present application claims priority under 35 U.S.C. 119(e) to provisional patent application Ser. No. 61/056,623, filed May 28, 2008, which is incorporated herein by reference in its entirety.

The present application is related to the following U.S. Patent Applications:

EDGE DEVICE THAT ENABLES EFFICIENT DELIVERY OF VIDEO TO HANDHELD DEVICE (BP7072), having Ser. No. 12/172,088 filed on Jul. 11, 2008; and

EDGE DEVICE RECEPTION VERIFICATION/NON-RECEPTION VERIFICATION LINKS TO DIFFERING DEVICES (BP7073), having Ser. No. 12/172,130 filed on Jul. 11, 2008, both of which are incorporated herein their entirety; and

EDGE DEVICE ESTABLISHING AND ADJUSTING WIRELESS LINK PARAMETERS IN ACCORDANCE WITH QOS-DESIRED VIDEO DATA RATE (BP7074), having Ser. No. ______, filed on ______.

### BACKGROUND

1. Technical Field of the Invention

This invention relates generally to video/audio content transport, and more particularly to the preparation, transportation, and receipt of such video/audio content.

2. Related Art

The broadcast of digitized video/audio information (multimedia content) is well known. Limited access communication networks such as cable television systems, satellite television systems, and direct broadcast television systems support delivery of digitized multimedia content via controlled transport medium. In the case of a cable modem system, a dedicated network that includes cable modem plant is carefully controlled by the cable system provider to ensure that the multimedia content is robustly delivered to subscribers' receivers. Likewise, with satellite television systems, dedicated wireless spectrum robustly carries the multi-media content to subscribers' receivers. Further, in direct broadcast television systems such as High Definition (HD) broadcast systems, dedicated wireless spectrum robustly delivers the multi-media content from a transmitting tower to receiving devices. Robust delivery, resulting in timely receipt of the multimedia content by a receiving device is critical for the quality of delivered video and audio.

Some of these limited access communication networks now support on-demand programming in which multimedia content is directed to one, or a relatively few number of receiving devices. The number of on-demand programs that can be serviced by each of these types of systems depends upon, among other things, the availability of data throughput between a multimedia source device and the one or more receiving devices. Generally, this on-demand programming is initiated by one or more subscribers and serviced only upon initiation.

Publicly accessible communication networks, e.g., Local Area Networks (LANs), Wireless Local Area Networks (WLANs), Wide Area Networks (WANs), Wireless Wide Area Networks (WWANs), and cellular telephone networks, have evolved to the point where they now are capable of providing data rates sufficient to service streamed multimedia content. The format of the streamed multimedia content is similar/same as that that is serviced by the limited access networks, e.g., cable networks, satellite networks. However, each of these communication networks is shared by many users that compete for available data throughput. Resultantly, streamed multimedia content is typically not given preferential treatment by these networks.

Generally, streamed multimedia content is formed/created by a first electronic device, e.g., web server, personal computer, user equipment, etc., transmitted across one or more communication networks, and received and processed by a second electronic device, e.g., personal computer, laptop computer, cellular telephone, WLAN device, or WWAN device. In creating the multimedia content, the first electronic device obtains/retrieves multimedia content from a video camera or from a storage device, for example, and encodes the multimedia content to create encoded audio and video frames according to a standard format, e.g., Quicktime, (motion picture expert group) MPEG-2, MPEG-4, or H.264, for example. The encoded audio and video frames are placed into data packets that are sequentially transmitted from the first electronic device onto a servicing communication network, the data packets addressed to one or more second electronic device(s). The sequentially transmitted sequence of encoded audio/video frames may be referred to as a video stream or an audio/video stream. One or more communication networks carry the data packets to the second electronic device. The second electronic device receives the data packets, reorders the data packets if required, and extracts the encoded audio and video frames from the data packets. A decoder of the second electronic device decodes the encoded audio and/or video frames to produce audio and video data. The second electronic device then stores the video/audio data and/or presents the video/audio data to a user via a user interface.

The audio/video stream may be carried by one or more of a number of differing types of communication networks, e.g., LANs, WANs, the Internet, WWANs, WLANs, cellular networks, etc. Some of these networks may not support the audio/video stream reliability and/or with sufficient data rate, resulting in poor quality audio/video at the second electronic device. Thus, a need exists for a structures and operations for the formation, transmission, and receipt of audio/video streams across such networks. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

The present invention is directed to apparatus and methods of operation that are further described in the following Brief Description of the Drawings, the Detailed Description of the Drawings, and the claims. Other features and advantages of the present invention will become apparent from the following detailed description of the invention made with reference to the accompanying drawings.

### BRIEF DESCRIPTION OF THE DRAWINGS

FIG. 1 is a flow chart illustrating operations for area of interest video processing according to one or more embodiments of the present invention;

FIG. 2 is a flow chart illustrating operations for video processing within an area of interest according to one or more embodiments of the present invention;

FIG. 3 is a system diagram illustrating a communication system that operates according to one or more embodiment of the present invention;

FIG. 4 is a block diagram illustrating a wireless device constructed and operating according to one or more embodiments of the present invention;

FIG. 5 is a block diagram illustrating a video processing system constructed and operating according to at least one embodiment of the present invention;

FIG. 6 is a flow chart illustrating operations for receiving area of interest selection(s) by a wireless device via one or more user interfaces according to one or more embodiments of the present invention;

FIG. 7 is a flow chart illustrating operations for extracting area of interest information by a video processing system from video frames of a video stream according to one or more embodiments of the present invention;

FIG. 8 is a flow chart illustrating operations for requesting and receiving area of interest information by a video processing system from a remote device according to one or more embodiments of the present invention; and

FIG. 9 is a diagram illustrating area of interest processing of video frames of a video stream according to one or more embodiments of the present invention.

### DETAILED DESCRIPTION OF THE DRAWINGS

Generally, according to embodiments of the present invention, a video stream is processed based upon area of interest information to modify the characteristics of the video stream. In particular, an area of interest may be identified based upon area of interest information received from a destination remote wireless device, from the video stream itself, or from another device. Processing of the video stream based upon the area of interest information is performed by a video processing system. The video processing system may perform the area of interest processing to accommodate an available throughput or bandwidth for carrying the video stream from the video processing system to the remote wireless device.

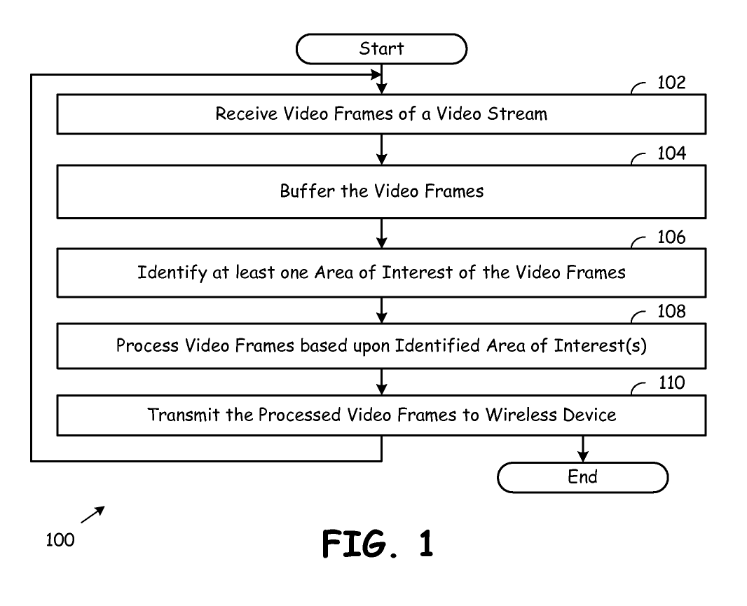

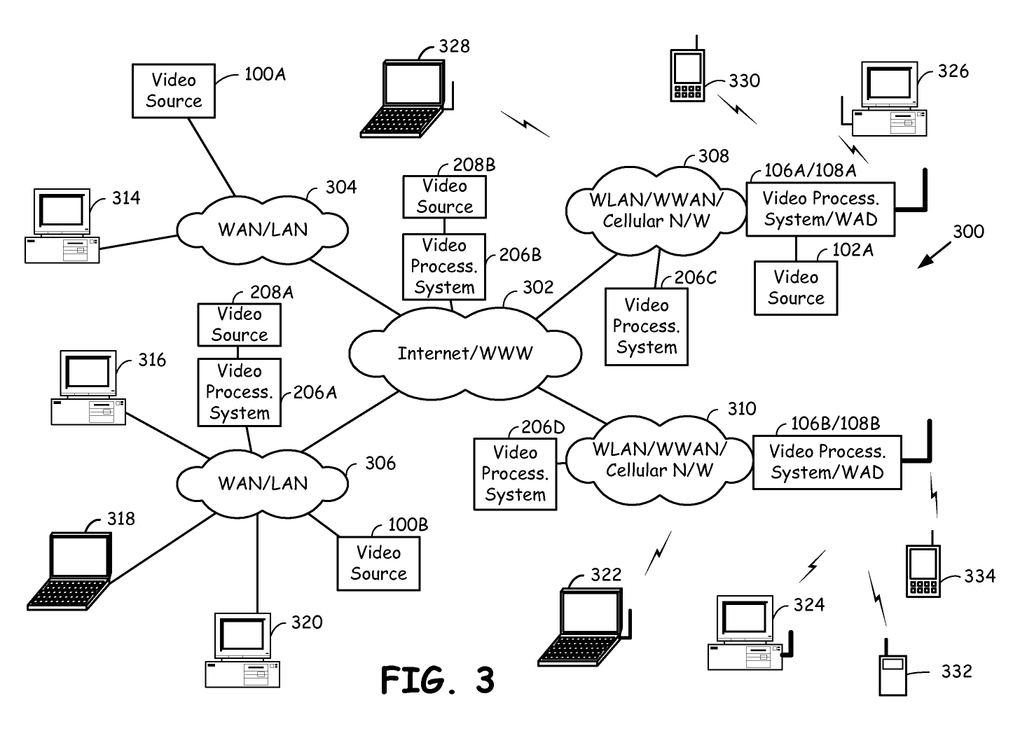

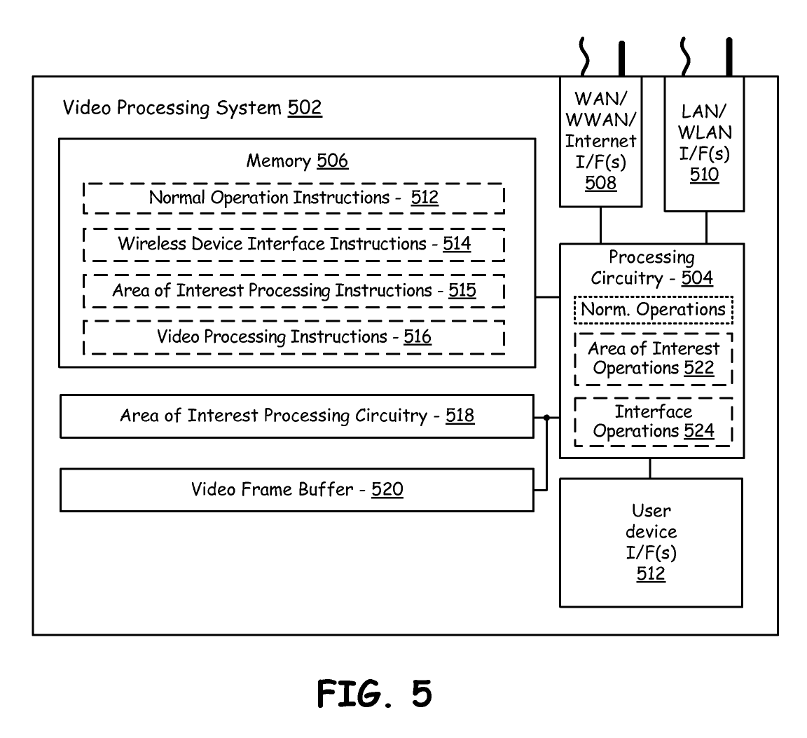

FIG. 1 is a flow chart illustrating operations for area of interest video processing according to one or more embodiments of the present invention. The operations 100 of FIG. 1 include first receiving video frames of a video stream by a video processing system (Step 102). Examples of video processing systems that may perform the operations 100 of FIG. 1 will be illustrated and described further with reference to FIGS. 3 and 5. After receipt of the video frames of the video stream, the video processing system buffers the video frames (Step 104). Buffering of the video frames may be accomplished via system memory of the video processing system or by a dedicated video frame buffer, for example.

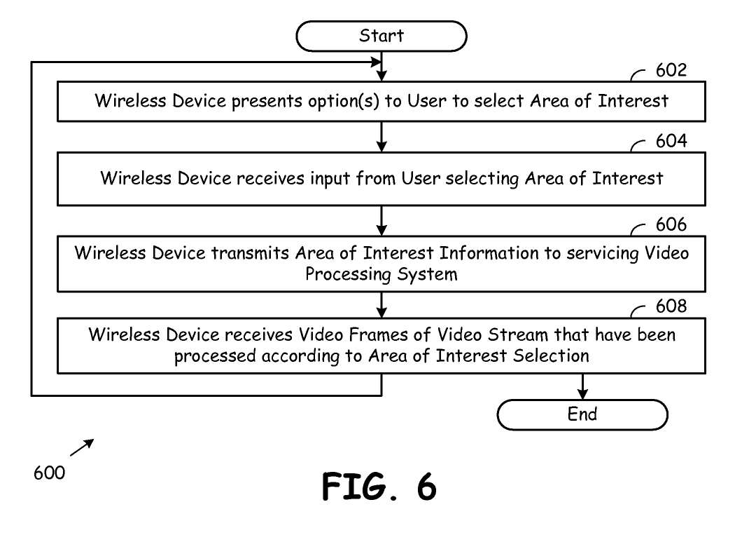

After the video frames are buffered by the operation of Step 104, the video processing system identifies at least one area of interest of the video frames (Step 106). As will be further described with reference to FIGS. 6-9, one or more areas of interest are identified based upon area of interest information. The area of interest information may be received from a remote wireless device, extracted from the video frames of the video stream, be received from a remotely located device, or via other means.

After at least one area of interest of the video frames is identified, operations 100 include processing the video frames of the video stream based upon the identified area(s) of interest (Step 108). The video processing system, based upon the area of interest processing, produces processed video frames of an output video stream that have characteristics that differ from the video frames of the input video stream received at Step 102. After producing the output video stream, the video processing system transmits the video frames of the output video stream to the remote wireless device (Step 110). According to some aspects of the present invention, the output video stream is transmitted to the remote wireless device via at least one wireless link. Characteristics of the wireless link may change over time based upon allocated spectrum, a location of the remote wireless device, and/or based upon other characteristics of a servicing wireless network. Thus, area of interest processing may change over time during the duration of transport of the video stream to the remote wireless device. Thus, the operations 100 of FIG. 1 embodied by Steps 102-110 may change over time as characteristics of one or more servicing wireless links change.

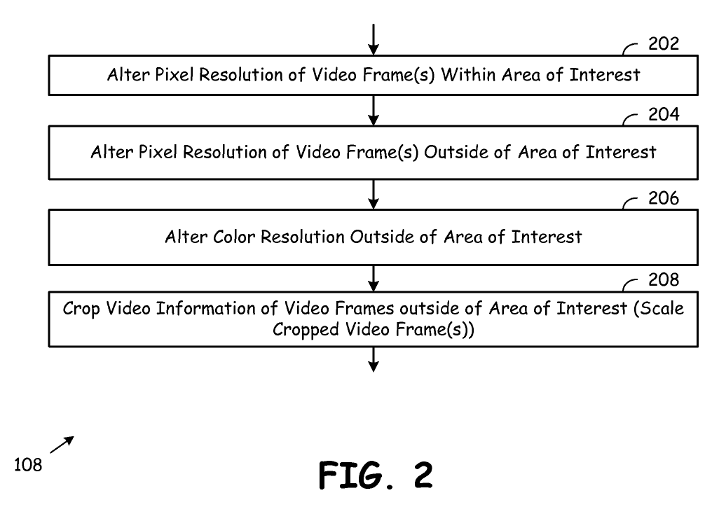

FIG. 2 is a flow chart illustrating operations for video processing within an area of interest according to one or more embodiments of the present invention. The operations 108 of FIG. 2 may be partially or fully applied to the video frames of the input video stream by a video processing system. Thus, various operations performed at Step 108 of FIG. 1 are shown sequentially in FIG. 2. The operations 108 of FIG. 2 may be executed singularly or in any combination thereof. Generally, the operations 108 of FIG. 2 may vary over time based upon characteristics of a transport path between the video processing system and the remote wireless device or other operating criteria that change over time. The transport path may include both wired and wireless links. These wired and wireless links may change or may have differing characteristics over time requiring differing area of interest processing by the video processing system.

The operations 108 of FIG. 2 may include, for example, altering a pixel resolution of video frames within the area of interest (Step 202). Further, the operations 108 of FIG. 2 may include altering a pixel resolution of video frames outside of the area of interest (Step 204). Examples of altering pixel resolution of video frames outside of the area of interest of Step 204 may include decreasing pixel resolution of the video frames outside of the area of interest, reducing color resolution of the video frames outside of the area of interest (Step 206) and/or removing color content of the video frame outside of the area of interest. Further, processing video frames according to operations 108 of FIG. 2 may include cropping information of the video frames outside of the area of interest (Step 208). The operations of Step 206 may further include scaling the cropped video frames to fit a display of the remote wireless device (also at Step 208). Thus, in conclusion, the operations of Step 108 are examples of area of interest processing according to the present invention. Of course, other area of interest processing may be performed without departing from the scope and spirit of the present invention.

FIG. 3 is a system diagram illustrating a communication system that operates according to one or more embodiment of the present invention. The system 300 of FIG. 3 includes a plurality of communication networks 302, 304, 306, 308, and 310 that service a plurality of electronic devices 314, 316, 318, 320, 322, 324, 326, 328, 330, 332, and 334. These communication networks include the Internet/World Wide Web (WWW) 302, one or more Wide Area Networks/Local Area Networks (WANs/LANs) 304 and 306, and one or more Wireless Wide Area Networks/Wireless Local Area Networks/Cellular networks (WLANs/WWANs/Cellular networks) 308 and 310. The Internet/WWW 302 is generally known and supports Internet Protocol (IP) operations. The WANs/LANs 304 and 306 support electronic devices 314, 316, 318, and 320 and support IP operations. The WLANs/WWANs/Cellular networks 308 and 310 support wireless devices 322, 324, 326, 328, 330, 332, and 334.

The WLAN/WWAN/Cellular networks 308 and 310 operate according to one or more wireless interface standards, e.g., IEEE 802.11x, WiMAX, GSM, EDGE, GPRS, WCDMA, CDMA, 1xEV-DO, 1xEV-DV, etc. The WLAN/WWAN/Cellular networks 308 and 310 include a back-haul network that couples to the Internet/WWW 302 and service wireless links for wireless devices 322, 324, 326, 328, 330, 332, and 334. In providing this wireless service, the WLAN/WWAN/Cellular networks 308 and 310 include infrastructure devices, e.g., Access Points and base stations to wirelessly service the electronic devices 322, 324, 326, 328, 330, 332, and 334. The wireless links serviced by the WLAN/WWAN/Cellular networks 308 and 310 are shared amongst the wireless devices 324-334 and are generally data throughput limited. Such data throughput limitations result because the wireless links are shared, the wireless links are degraded by operating conditions, and/or simply because the wireless links have basic data throughput limitations.

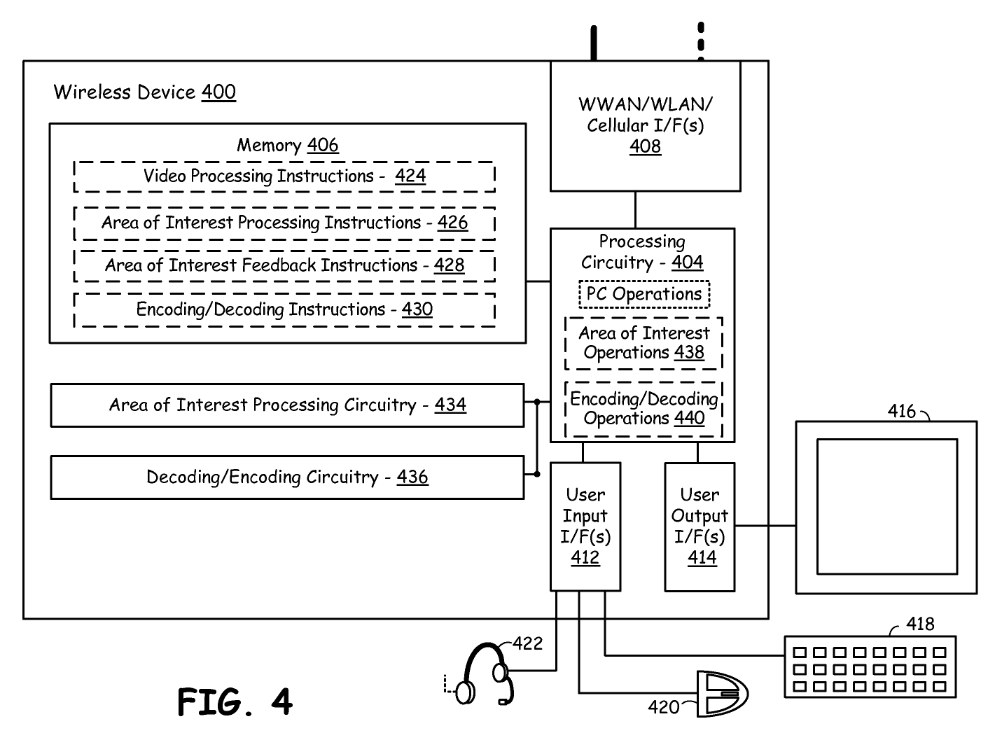

According to operations of the system 300 of FIG. 3, any of the devices 314, 316, 318, or 320, any of the video sources 100A, 100B, 102A, 208A, and/or 208B, and/or any of the video processing systems 106A, 106B, 206A, 206B, 206C, or 206D may operate as a video processing system according to the operations described with reference to FIGS. 1 and 2 and as will be further described with reference to FIGS. 6-9. Further each of the wireless devices 322, 324, 326, 328, 330, 332, of 334 may serve and operate as a remote wireless device as was described with reference to FIGS. 1 and 2 and as will be further described with reference to FIGS. 4 and 6-9. Note that with the embodiments of FIG. 3, video processing system 106A and wireless access device 108A are shown as a single block and video processing system 106B and wireless access device 108B are shown as a single block. This indicated structure does not necessarily indicate that these devices share a physical structure, only that they are coupled functionally at the edge of networks 308 and 310, respectively.

FIG. 4 is a block diagram illustrating a wireless device constructed and operating according to one or more embodiments of the present invention. The wireless device 400 is representative of an embodiment of one or more of the wireless devices 322, 324, 326, 328, 330, 332, of 334 of FIG. 3, for example. The components of wireless device 400 are generically illustrated. Particular embodiments of the wireless device 400 of FIG. 4 may include some, most, or all of the components that are illustrated in FIG. 4.

Generally, the wireless device 400 includes processing circuitry 404, memory 406, wireless network interface 408, user input interfaces 412, and user output interfaces 414. The user input interfaces 412 couple to headset 422, mouse 420, and keyboard 418. The user output interfaces 414 couple to audio/video display device 416. The user output interface 414 may also couple to headphone 422. The display device 416 may include a monitor, projector, speakers, and other components that are used to present the audio and video output to a user. While these components of the wireless device are shown to be physically separate, all of these components could be housed in a single enclosure, such as that of a handheld device. The wireless device 400 embodies the structure and performs operations of the present invention with respect to area of interest processing. Thus, the wireless device 400 operates consistently with the operations and structures previously described with reference to FIGS. 1-3 and as will be described further with reference to FIGS. 6-9.

In one particular construct of the wireless device 400, dedicated hardware is employed for video processing, e.g., area of interest processing/feedback operations, encoding operations, and/or decoding operations. In such case, the wireless device 400 includes area of interest processing circuitry 434 and decoding/encoding circuitry 436. Alternatively, are additionally, the wireless device 400 services area of interest processing and feedback operations and decoding/encoding operations using non-dedicated resources. In such case, these operations of wireless device 400 are serviced by processing circuitry 404. The processing circuitry 404 performs, in addition to its PC operations, area of interest processing operations 438, and encoding/decoding operations 440. In such case, particular hardware may be included in the processing circuitry 404 to perform the operations 438 and 440. Alternatively, area of interest operations 438 and encoding/decoding operations 440 are performed by the execution of software instructions using generalized hardware (or a combination of generalized hardware and dedicated hardware). In this case, the processing circuitry 404 retrieves video processing instructions 424, area of interest processing instructions 426, area of interest feedback instructions 428, and/or encoding/decoding instructions 430 from memory 406. The processing circuitry 404 executes these various instructions 424, 426, 428, and/or 430 to perform the indicated functions. Execution of these instructions 424, 426, 428, and/or 430 causes the wireless device 400 to interface with the video processing system to perform operations described with reference to FIGS. 1-3 and 6-9. Processing circuitry 404 may include one or more processing devices such as microprocessors, digital signal processors, application specific processors, or other processing type devices. Memory 406 may be any type of digital memory, volatile, or non-volatile, capable of storing digital information such as RAM, ROM, hard disk drive, Flash RAM, Flash ROM, optical drive, or other type of digital memory.

Generally, the wireless device 400 receives a video stream (video/audio stream) that is carried by data packets via the network interface 408 and processes the received video stream. Further, the wireless device 400, in some operations, elicits area of interest information from a user and provides this area of interest information to a video processing system via interaction therewith. In still other operations, the wireless device 400 may output a video stream within data packets via network interface 408 to another device. The network interface 408 supports one or more of WWAN, WLAN, and cellular wireless communications. Thus, the wireless interface 408, in cooperation with the processing circuitry 404 and memory supports the standardized communication protocol operations in most embodiments that have been previously described herein.

FIG. 5 is a block diagram illustrating a video processing system constructed and operating according to at least one embodiment of the present invention. The video processing system 502 may correspond to one of devices 314, 316, 318, or 320, video sources 100A, 100B, 102A, 208A, and/or 208B, and/or any of the video processing systems 106A, 106B, 206A, 206B, 206C, or 206D of FIG. 3. The video processing system 502 includes processing circuitry 504, memory 506, network interfaces 508 and 510, user device interfaces 512, and may include area of interest video processing circuitry 518 and video frame buffer 520. The processing circuitry 504 may include one or more processing devices such as microprocessors, digital signal processors, application specific processors, or other processing type devices. Memory 506 may be any type of digital memory, volatile, or non-volatile, capable of storing digital information such as RAM, ROM, hard disk drive, Flash RAM, Flash ROM, optical drive, or other type of digital memory. The first network interface 508 supports WAN/WWAN/Internet interface operations while the second network interface 510 supports LAN and WLAN interface operations. Of course, in differing embodiments a single network interface may service all necessary communication interface operations and in still other embodiments, additional network interfaces may be employed.

The video processing system 502 performs the video processing system operations previously described with reference to FIGS. 1-3 and that will be further described herein with reference to FIGS. 6-9. To accomplish these operations, the video processing system 502 includes processing circuitry 504, memory 506, first and second network interfaces 508 and 510, user device interface 512, and may include the specialized circuitry, i.e., the area of interest processing circuitry 518 and the video frame buffer 520. The operations of the video processing system 502 may also/otherwise be implemented by the processing circuitry 504. In such case, the processing circuitry 504, in addition to its normal operations, may perform area of interest processing operations 522 and interface operations 524. In its operations, the processing circuitry 504 retrieves software instructions from memory and executes these software instructions, which include normal operation instructions 512, wireless device interface instructions 514, area of interest processing operations 515, and video processing instructions 516.

FIG. 6 is a flow chart illustrating operations for receiving area of interest selection(s) by a wireless device via one or more user interfaces according to one or more embodiments of the present invention. The operations 600 of FIG. 6 describe an embodiment with a user of a remote wireless device identifying an area of interest via one or more user input and output interfaces of the remote wireless device. According to the operations 600 of FIG. 6, the remote wireless device presents one or more options to a user to select an area of interest relating to one or more video frames of an incoming video stream (Step 602). These options may be presented via a display, an input interface, or via another user interface of the remote wireless device. In such case, after the options are presented to the user to select an area of interest at Step 602, the wireless device receives input from the user in the selection of an area of interest (Step 604). Alternatively, the operations of Step 604 may include receiving input from the user to select a plurality of areas of interest via one or more user input devices.

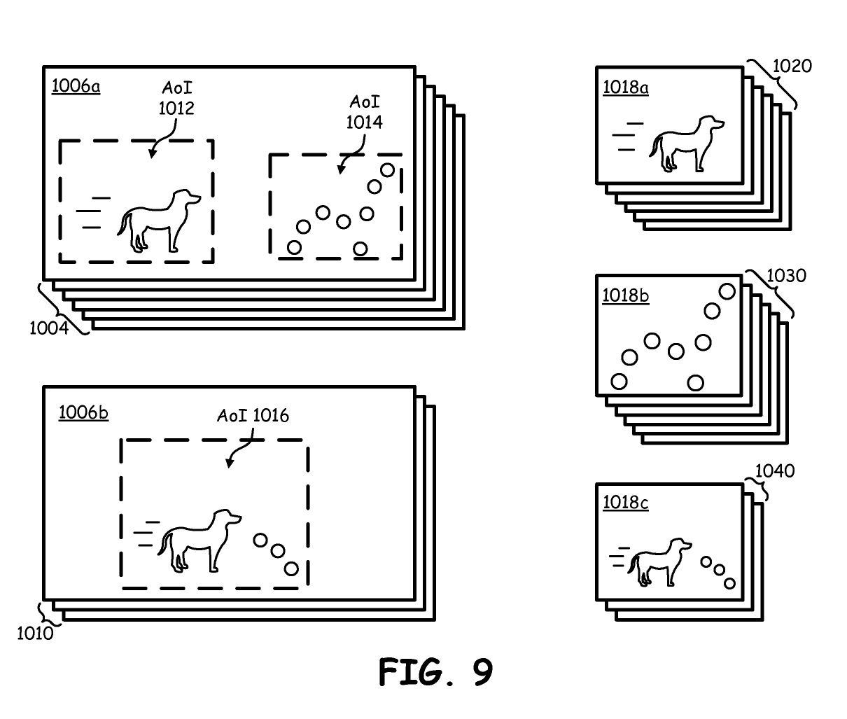

With one particular example of the operations 600 of FIG. 6, the remote wireless device includes a touch screen that the user employs to select a portion of one or more video frames of the incoming video stream with his or her fingers or using a stylus. In another embodiment, the wireless device includes a display and a user input device such as a cursor or another input device to identify one or more areas of interest on the display. Stated differently, the remote wireless device presents video to the user that the user may employ to select an area of interest thereupon. The user may select a representative frame of the video with which to select the area of interest(s). Examples of the methodology for selection of area of interest are shown further with respect to FIG. 9 described therewith. Effectively, the user selects an area of the video presentation that represents a subset of the displayed video presentation presented to the user via the display. Alternatively, the wireless device may simply present the user with a menu of options allowing user to select a centralized portion of the video displayed upon the display of the wireless device, e.g., central portion of displayed video, right portion of the displayed video, left portion of the displayed video, or another portion of the displayed video. In response thereto, the wireless device, based upon the selection of the user, produces area of interest information representative of the identified area of interest(s).

The operations 600 of FIG. 6 continue with the wireless device transmitting the area of interest information to the video processing system (Step 606). The area of interest information transmitted at Step 606 is based upon the user input causing the selection at Step 604. Subsequently, the wireless device receives video frames of the video stream that have been processed according to the area of interest information. The operations 600 of FIG. 6 may continue throughout duration of the transport of the video stream from the video processing system to the remote wireless device. For example, the supported data throughput from the video processing system to the remote wireless device may change over time. Thus, during some period of time when the throughput is reduced due to system operating conditions, it may be required to reduce the data requirements of the video stream by performing area of interest processing. In one example of this operation, after area of interest processing, the video stream has a second video stream format wherein prior to the area of interest processing, the video stream had a first video stream format. In such case, the video stream having the second video stream format requires less transmission bandwidth than does the video stream having the first video stream format. Such processing may be performed to address reduced data throughput requirements.

Then, when these data throughput requirements are lifted, the video processing system may revert to a transmission or transport of all information of the video frames of the video stream. Then, when data throughput is again limited by one or more servicing wireless networks, the video processing system may use the previously received area of interest information from the remote wireless device and again process the video frames and the video stream to reduce their effective data throughput requirement wherein the video stream having the second video stream format requires less transmission bandwidth than does the video stream having the first video stream format.

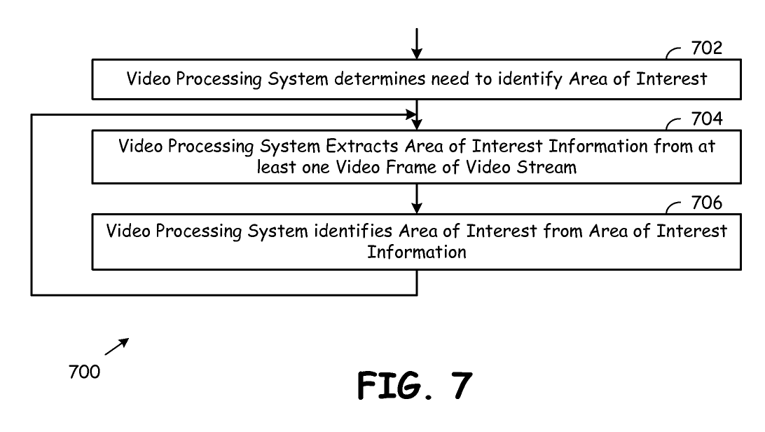

FIG. 7 is a flow chart illustrating operations for extracting area of interest information by a video processing system from video frames of a video stream according to one or more embodiments of the present invention. The operations 700 of FIG. 7 commence with the video processing system determining a need to identify an area of interest (Step 702). As was previously described, the area of interest processing may only be required when a transport path carrying the video stream from the video processing system to the remote wireless device cannot support transport of the full video stream. After determination of the need for area of interest processing by the video processing system, the video processing system extracts area of interest information from at least one video frame of the video stream (Step 704). Operation continues with the video processing system identifying an area of interest (or more than one area of interest) from the area of interest information (Step 706). According to some embodiments of the present invention, if the area of interest information contained within at least one video frame of the video stream and extracted at Step 704 may have to be decoded or otherwise expanded in order to relate the identification of the area of interest to the one or more video frames of the video stream. Thus, the operation 700 of FIG. 7 will allow the video processing system to identify the area of interest(s) for subsequent area of interest processing at Step 108 of FIG. 1.

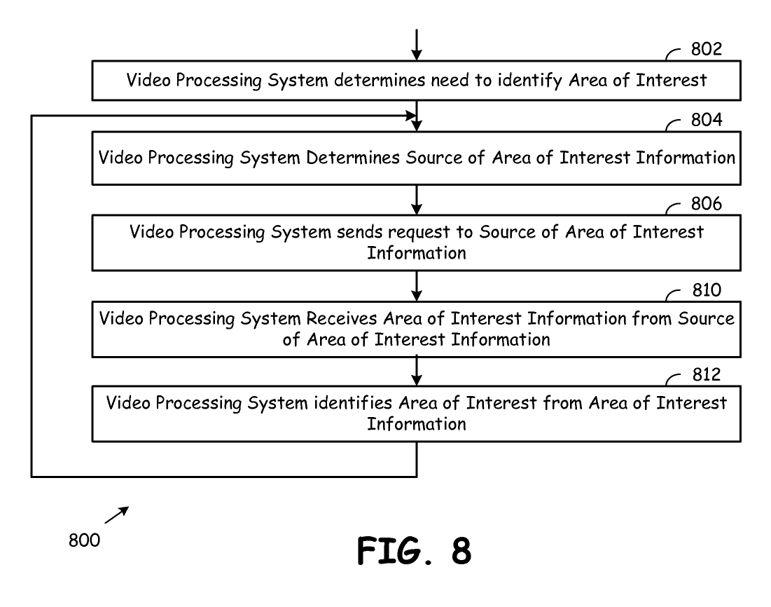

FIG. 8 is a flow chart illustrating operations for requesting and receiving area of interest information by a video processing system from a remote device according to one or more embodiments of the present invention. The operations 800 of FIG. 8 include the video processing system first determining a need to identify an area of interest (Step 802). The determination of such a need has been previously described herein with reference to the prior FIGs. Operations 800 continue with the video processing system determining a source of area of interest information (Step 804). The source of the area of interest information determined at Step 804 may be an area of interest information server, a source of the video stream, i.e., a video source, or another location within the system illustrated with reference to FIG. 3, for example.

After the video processing system identifies the source of the area of interest information, it sends a request to the source of the area of interest information for the area of interest information regarding the currently serviced video stream (Step 806). The video processing system then receives the area of interest information from the source of the area of interest information (Step 810). The video processing system then identifies the area of interest or multiple areas of interests within video frames of the video stream from the area of interest information (Step 812). The area of interest identified at Step 812 is then used at Step 108 of FIG. 1 to process video frames of the video stream. The operations of 800 illustrated at Steps 804-812 may continue throughout the duration of the transport of the video stream from the video processing system to the remote wireless device. As was previously described, area of interest processing may vary over time based upon the available transport throughput from the video processing system to the remote wireless device.

FIG. 9 is a diagram illustrating area of interest processing of video frames of a video stream according to one or more embodiments of the present invention. Illustrated in FIG. 9 are sequences of video frames 1004 and 1010 prior to area of interest processing and sequences of video frames 1020, 1030, and 1040 produced by area of interest processing. With the example of FIG. 10, an incoming video stream may be viewed as a sequentially received plurality of video frames. For example, a plurality of video frames 1004 of an incoming video stream includes a first video frame 1006a and subsequent video frames. Video frame 1006a may include two separately identified areas of interest 1012 and 1014. The information identifying these areas of interest may be included with the video frames themselves or be received by the video processing system as separate information from a video source that supplies the incoming video stream, from a remote destination wireless device, or from another source, for example. Likewise, a sequence of video frames 1010 of a video stream may include an area of interest 1016.

According to a first operation of a video processing system according to the present invention, the video processing system identifies the area of interest 1012 based upon the area of interest information and crops the video frame 1006a to produce video frame 1018a. In a like manner, the video processing system crops the plurality of video frames 1004 to produce a sequence of video frames 1020 that includes only information contained within area of interest 1012.

In a differing operating, video processing system identifies area of interest 1014 and crops video frame 1006a to produce video frame 1018b. Likewise, this area of interest 1014 may be employed to produce a series of video frames 1030 corresponding to area of interest 1014. In producing the output video stream for delivery to the remote wireless device, the video processing system may produce the sequence of video frames 1020 and/or the sequence of video frames 1030 to the remote wireless device. Because each of the video streams 1020 and 1030 includes less information than the sequence of video frames 1004 of the corresponding video stream, the data throughput required to transfer video sequence 1020 and/or 1030 as video stream(s) is less than that to transfer the sequence 1004 as a video stream.

Area of interest of processing by a video processing system may include identifying area of interest 1016 within video frame 1006b of a sequence of video frames 1010 of the incoming video stream based upon area of interest information. In processing the sequence of video frames 1010 of the incoming video stream, the video processing system may crop the video frame 1006b based upon the area of interest 1016 to produce video frame 1018c. Likewise, the video processing system may process each of the video frames 1010 of the incoming video stream to produce the sequence 1040 of video frames corresponding to area of interest 1016. In performing this area of interest processing, the video processing system may also effectively alter the pixel density of the output video stream by cropping the video frames of the video stream 1010. Alternatively, the video processing system may simply alter the resolution of each video frame of the video frame sequence.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A method for processing a video stream intended for a remote wireless device, the method comprising:
receiving the video stream;
identifying an area of interest corresponding to at least one video frame of the video stream;
processing video frames of the video stream based upon the identified area of interest to produce an output video stream; and
transmitting the output video stream for delivery to the remote wireless device.

2. The method of claim 1, wherein processing video frames of the video stream based upon the identified area of interest to produce an output video stream includes altering a pixel resolution of the video frames of the video stream within the area of interest.

3. The method of claim 1, wherein processing video frames of the video stream based upon the identified area of interest to produce an output video stream includes altering a pixel resolution of the video frames of the video stream outside of the area of interest.

4. The method of claim 3, wherein altering a pixel resolution of the video frames of the video stream outside of the area of interest to produce the output video stream includes at least one of:
decreasing pixel resolution of the video frames outside of the area of interest;
reducing color resolution of the video frames outside of the area of interest; and
removing color content of the video frames outside of the area of interest.

5. The method of claim 1, wherein processing video frames of the video stream based upon the identified area of interest to produce an output video stream includes cropping video information of the video frames outside of the area of interest.

6. The method of claim 5, further comprising scaling the cropped video frames to fit a display of the wireless device.

7. The method of claim 1, wherein identifying the area of interest corresponding to at least one video frame of the video stream comprises receiving area of interest selection information from the wireless device.

8. The method of claim 1, wherein identifying the area of interest corresponding to at least one video frame of the video stream comprises receiving area of interest information from a source of the video stream.

9. The method of claim 1, wherein identifying the area of interest corresponding to at least one video frame of the video stream comprises receiving area of interest information from an area of interest server.

10. A video processing system comprising:
a communications interface; and
processing circuitry coupled to the communications interface that, in cooperation with the communications interface, is operable to:
receive the video stream;
identify an area of interest corresponding to at least one video frame of the video stream;
process video frames of the video stream based upon the identified area of interest to produce an output video stream; and
transmit the output video stream for delivery to the remote wireless device.

11. The video processing system of claim 10, wherein in processing video frames of the video stream based upon the identified area of interest to produce an output video stream, the processing circuitry is operable to alter a pixel resolution of the video frames of the video stream within the area of interest.

12. The video processing system of claim 10, wherein in processing video frames of the video stream based upon the identified area of interest to produce an output video stream, the processing circuitry is operable to alter a pixel resolution of the video frames of the video stream outside of the area of interest.

13. The video processing system of claim 12, wherein the processing circuitry is operable to alter a pixel resolution of the video frames of the video stream outside of the area of interest to produce the output video stream by:
decreasing pixel resolution of the video frames outside of the area of interest;
reducing color resolution of the video frames outside of the area of interest; and
removing color content of the video frames outside of the area of interest.

14. The video processing system of claim 10, wherein in processing video frames of the video stream based upon the identified area of interest to produce an output video stream, the processing circuitry is operable to crop video information of the video frames outside of the area of interest.

15. The video processing system of claim 14, wherein in processing video frames of the video stream based upon the identified area of interest to produce an output video stream, the processing circuitry is further operable to scale the cropped video frames to fit a display of the wireless device.

16. The video processing system of claim 10, wherein the processing circuitry is operable to identify the area of interest corresponding to at least one video frame of the video stream by receiving area of interest selection information from the wireless device.

17. The video processing system of claim 10, wherein in processing video frames of the video stream based upon the identified area of interest to produce an output video stream, the processing circuitry is operable to identify the area of interest corresponding to at least one video frame of the video stream comprises by receiving area of interest information from a source of the video stream.

18. The video processing system of claim 10, wherein identifying the area of interest corresponding to at least one video frame of the video stream comprises receiving area of interest information from an area of an area of interest server.

19. A method for processing a video stream intended for a remote wireless device, the method comprising:
receiving the video stream by the remote wireless device, the video stream having a first video stream format;
identifying, based upon user input, an area of interest corresponding to at least one video frame of the video stream;
transmitting, by the wireless device to a remote video processing system, area of interest information regarding the identified area of interest;
receiving the video stream by the remote wireless device, the video stream having a second video stream format that is based upon the area of interest information.

20. The method of claim 19, wherein, as compared to its first video stream format, the video stream in its second video stream format has at least one of:
a differing video frame resolution;
a differing pixel resolution within the area of interest;
a differing pixel resolution outside of the area of interest;
a differing color resolution outside of the area of interest; and
differing color content outside of the area of interest.

21. The method of claim 19, wherein the video stream having the second video stream format requires less transmission bandwidth than does the video stream having the first video stream format.

22. A wireless device comprising:
a communications interface; and
processing circuitry coupled to the communications interface that, in cooperation with the communications interface, is operable to:
receive a video stream having a first video stream format;
identify, based upon user input, an area of interest corresponding to at least one video frame of the video stream;
transmit to a remote video processing system area of interest information regarding the identified area of interest;
receive the video stream having a second video stream format that is based upon the area of interest information.

23. The wireless device of claim 22, wherein, as compared to its first video stream format, the video stream in its second video stream format has at least one of:
a differing video frame resolution;
a differing pixel resolution within the area of interest;
a differing pixel resolution outside of the area of interest;
a differing color resolution outside of the area of interest; and
differing color content outside of the area of interest.

24. The method of claim 22, wherein the video stream having the second video stream format requires less transmission bandwidth than does the video stream having the first video stream format.
